(19) United States
(12) Patent Application Publication
(10) Pub. No.: US 2023/0329306 A1
(43) Pub. Date: Oct. 19, 2023

(54) COMPOSITIONS COMPRISING INSOLUBLE CORN FIBER

(71) Applicant: Cargill, Incorporated, Wayzata, MN (US)

(72) Inventors: Baris Ozalp, Atasehir, Istanbul (TR); Yaman Can Saraclar, Atasehir, Istanbul (TR); Burcak Taskin, Atasehir, Istanbul (TR)

(73) Assignee: Cargill, Incorporated, Wayzata, MN (US)

(21) Appl. No.: 18/044,594

(22) PCT Filed: Sep. 16, 2021
(86) PCT No.: PCT/US2021/050684

§ 371 Date: Mar. 9, 2023

(30) Foreign Application Priority Data
Sep. 16, 2020 (EP) 20196363.4

(51) Int. Cl. A23L 33/24; A23L 13/60; A23L 13/40; A23L 5/20

(52) U.S. Cl. CPC A23L 33/24; A23L 13/65; A23L 13/426; A23L 5/27

(57) ABSTRACT

The present invention relates to a food-grade composition rich in insoluble corn fiber and having a good water absorption capacity, which can be used in processed meats, plant-based meat alternative products and in hybrid restructured meat products. The present invention also relates to a process for preparing a food-grade composition rich in insoluble corn fiber and having a good water absorption capacity, which can be used in processed meats, plant-based meat alternative products and in hybrid restructured meat products.

### CROSS-REFERENCE TO RELATED APPLICATIONS

This application claims the benefit of European Patent Application No. 20196363.4, filed Sep. 16, 2020, which is incorporated by reference herein in its entirety.

### FIELD OF THE INVENTION

The present invention relates to a food-grade composition rich in insoluble corn fiber and having a good water absorption capacity, which can be used in processed meats, plant-based meat alternative products and in hybrid restructured meat products.

### BACKGROUND OF THE INVENTION

Consumer demand for healthy superfoods is driving the market for insoluble fibers. This market has also benefited from a growing body of research linking regular intake of insoluble fibers to lower risk of gastrointestinal diseases, such as irritable bower syndrome (IBS). In addition, increasing consumer awareness on the role of insoluble fibers in lowering the risk of diverticulitis, constipation, and managing weight loss are all driving growth. Food manufacturers are thus looking to include insoluble fibers in their products in order to appeal to the ever more health-driven consumer.

Thus, there is a growing need in the food industry for more sources of natural plant-based insoluble fibers.

One type of insoluble fiber with commercial potential is insoluble corn fiber (also referred to as corn hull fiber or corn bran fiber), which can be extracted from corn, mainly from the tough fibrous outer layer or hull of the corn kernel or corn bran. Insoluble corn fiber is high in lignocellulosic components with cellulose and hemicellulose making up the majority of the composition. Insoluble corn fiber refers herein to both low and high molecular weight insoluble dietary fibers found in corn. Insoluble corn fiber comprises at least 50 wt % on a dry weight basis of hemicellulose and at least 20 wt % on a dry weight basis of cellulose.

Compositions rich in corn bran/fiber are normally obtained as a by-product from the production of corn starch. These are generally referred to as corn gluten feed and are currently widely used in animal feed. This is sold either wet to animal farms in the proximity of the plant, or first dried for easier transportation over longer distances.

To date, corn fibers/bran ingredients suitable for human consumption has limited availability on the market. Those corn fiber materials that have made it to the market have limited properties due to the way they have been extracted, which make it unsuitable for several different types of applications. Valorization of the by-products from wet-milled corn starch production to prepare a food-grade composition rich in insoluble corn fibers is one of the challenges the industry is facing. Several aspects render insoluble corn fibers obtained from the wet-milling process difficult to use for human consumption and in various food products.

The wet-milling process in corn starch extraction involves the use of an aqueous sulfur dioxide solution. The corn is steeped in this solution to soften the kernel so that the protein matrix is weakened allowing the starch granules to separate out cleanly. The sulfur dioxide also serves as an anti-microbial agent. According to European regulations, in order to be safe for human consumption the sulphur dioxide content should be less than 40 ppm in the final insoluble corn fiber ingredient. Sulphur dioxide is however also a known allergen. In order to avoid labelling with an allergen warning, the ingredient is required to have less than 10 ppm of sulphur dioxide.

Thus, there is a need to find a process that can remove the high sulphur dioxide content from insoluble fiber-rich side-streams coming from the wet-milling processing of corn to obtain corn bran/fibre suitable for human consumption.

The other challenge faced by the industry is the presence of mycotoxins in corn harvests. One of the most common is zearalenone, but also others such as deoxynivalenol and fumonisins (fumonisin B1, B2, B3, B4). Zearalenone (ZEN), also known as RAL and F-2 mycotoxin, is a potent estrogenic metabolite produced by some Fusarium and Gibberella species of fungi. Legislation to limit the amount of zearalenone and other known dangerous mycotoxins has been implemented in many parts of the world in order to minimize human health risk.

In many parts of Europe that are known for growing corn e.g., France, Belgium, Poland and Hungary, the frequency of Fusarium spp. occurrence has increased. This phenomenon is probably linked to warming climates, but also to wide-spread adoption of conservation tillage techniques combined with corn- and wheat-dominated crop rotation systems. These systems increase the likelihood of corn residues remaining on the soil surface promoting the survival of fungal pathogens as well as that of European corn borer larvae over the much warmer winters. This enhances the risk of Fusarium spp. developing during the growing season.

Thus, there is a need to use highly controlled sourcing of corn from regions unaffected by fungal diseases, such as Fusarium spp., to reduce or eliminate mycotoxin contamination for allowing the use of corn and its individual extracted and derived components in food products.

Finally, the side-streams rich in insoluble corn fibers e.g., corn gluten feed have a very high moisture content. In order to use such side-streams to prepare ingredients for use in various food products, with reduced risk of fouling and suitable for easy transportation, the wet fibrous compositions need to be sufficiently dried. However, the type of drying and the conditions used can have a big impact on the final properties of the ingredient. The type of harsh drying used to prepare dried corn gluten feed for feeding animals is not suitable. This kind of drying results in a final product with very low water absorption capacity.

Food manufacturers are looking to replace expensive meat-based constituents in processed meats, such as sausages. Novel food manufacturers are also adapting to growing trends of vegetarian and flexitarian diets to prepare plant-based meat alternatives or plant/meat hybrids with sensory properties similar to the full meat products. They require label-friendly, cost attractive, plant-based alternatives with good water absorption capacity. During manufacturing of the food product, but also upon cooking or curing by the consumer, the food product should retain its moisture content. Furthermore, loss of moisture from the food product in the packaging or when served is both visually unattractive for consumers and leads to negative perceptions of both taste and texture. At the same time, gelling (i.e., when water absorption capacity is too high) within the food product should be avoided.

Thus, there is also a need for better drying processes in order to obtain a composition rich in insoluble corn fiber with an ideal water absorption capacity (around 1:4 ratio of the fibre composition to water in weight), as well as providing the best appearance, taste and texture in the final food product.

The present invention aims to overcome all of the above challenges.

### SUMMARY OF THE INVENTION

The invention relates to a composition comprising at least 50 wt % insoluble corn fiber and having
a water absorption capacity of from 2 to 6 times the weight of the composition and
a sulphur dioxide content of less than 40 ppm.

The composition according to the invention consists of or essentially consists of components extracted or derived from corn, preferably extracted or derived from the wet-milling processing of corn.

The invention also relates to a food product comprising the composition according to the invention and one or more other food ingredients.

Furthermore, the invention relates to a process for preparing the composition according to the invention comprising the following steps:
i) Providing a fibrous composition comprising insoluble corn fiber, wherein the fibrous composition is obtainable as a side-stream from the wet-milling processing of corn, wherein the fibrous composition has a water content of at least 40 wt %, preferably at least 50 wt %, more preferably at least 55 wt %;
ii) Treating the composition with a neutralizing agent to reduce the level of sulphur dioxide in the fibrous composition to below 40 ppm, preferably less than 20 ppm, more preferably less than 10 ppm;
iii) Drying the fibrous composition;
iv) Obtaining a dried composition comprising insoluble corn fiber having a water content of less than 15 wt %, preferably less than 12 wt %, more preferably less than 10 wt %, most preferably less than 8 wt %; and
v) Optionally, milling or sieving the dried composition.

### DETAILED DESCRIPTION OF THE INVENTION

The invention relates to a composition comprising at least 50 wt % insoluble corn fiber on a dry weight basis and having
a water absorption capacity of from 2 to 6 times the weight of the composition and
a sulphur dioxide content of less than 40 ppm.

The composition according to the invention is obtainable from a side-stream from the wet-milling processing of corn, often referred to as the side-stream for corn gluten feed.

All of the features described in the following sections can be combined.

### Insoluble Corn Fiber Content

The composition has a content of at least 50 wt % insoluble corn fiber. Preferably the composition comprises at least 55 wt %, more preferably at least 60 wt %, most preferably at least 65 wt % of insoluble corn fiber on a dry weight basis.

Insoluble corn fiber refers to both low and high molecular weight insoluble dietary fibers found in corn. Insoluble corn fiber comprises at least 50 wt %, preferably at least 60 wt %, more preferably at least 70 wt %, on a dry weight basis of hemicellulose. Furthermore, insoluble corn fiber can comprise at least 20 wt %, preferably at least 25 wt %, more preferably at least 28 wt %, on a dry weight basis of cellulose.

The amount of insoluble corn fiber can be measured according to method AOAC 2011.25.

### Water Absorption Capacity and Water Holding Capacity

Water absorption capacity indicates the instant water binding ability of the composition according to the invention. This is an important parameter to understand how it will behave during the preparation of a final food product, for example in a meat-based or vegetarian sausage. The composition according to the invention has a water absorption capacity of from 2 to 6 times the weight of the composition, preferably 3 to 5 times the weight of the composition, more preferably about 3.5 to 4.5 times the weight of the composition, most preferably about 4 times the weight of the composition.

### Measurement Method for Water Absorption Capacity:

When it is expected that the composition binds not more than 4 times its weight in water, 4 units (by weight) of water are added to 1 unit (by weight) of the composition to be measured and gently mixed together in a conventional mixer at 1000 rpm for 1 minute at ambient temperature. This mixing generally mimics the processes used during the food product production.

If all the water is absorbed, then it can be said that the composition has a water absorption capacity of 1:4.

If any water remains unabsorbed, this water is decanted from the mixture and weighed. The water absorption capacity, which will be less than 1:4, can then be calculated.

When a water absorption capacity of more than 1:4 is expected, 5 times or 6 times (as appropriate) the weight of the composition in water can be added (instead of 4 times the weight) to measure the exact water absorption capacity as indicated above.

Water holding capacity (WHC) of the composition is used to understand if the composition is prone to release absorbed water after a certain amount of time and/or after application of heat. This is also an important parameter to understand how the composition will behave during and after the preparation of a final food product, for example in a meat-based or vegetarian sausage. Ideally, for applications in processed meat-based (or vegetarian alternative) food products, the insoluble fibres should not release any of the absorbed water even after 24 hours at ambient temperature, heating or application of mechanical stress.

It was found that regardless of which of the conditions below was applied, in all instances, the composition according to the invention did not release any absorbed water. The water holding capacity was the same as the instant water absorption capacity as measured above, and did not change as a function of time or temperature. Furthermore, even when applying an amount of mechanical stress typically observed during food production e.g., mixing, tumbling, drying, extruding, pumping, filling, cutting etc. the composition according to the invention did not release hardly any absorbed water. The water absorption capacity and water holding capacity are equivalent for the composition according to the invention.

### Measurement Method for Water Holding Capacity:

After measuring the water absorption capacity as indicated above, the relevant WHC can be determined by measuring the water absorption after applying one of the following conditions:
For WHC24 hr, RT: The mixture is kept at ambient temperature for 24 hours.
For WHC24 hr, 40° C.: The mixture is heated to 40° C. and kept at 40° C. for 24 hours.
For WHC 1 hr, 90° C.: The mixture is heated to 90° C. and kept at 90° C. for 1 hour.

If any water is released thereafter, this water is decanted from the mixture and weighed. The relevant WHC can then be calculated.

### Sulphur Dioxide Content

The composition according to the invention has a sulphur dioxide content that is less than 40 ppm, preferably less than 30 ppm, more preferably less than 20 ppm, even more preferably less than 15 ppm, most preferably less than 10 ppm.

A content of less than 40 ppm sulphur dioxide is required in order for the composition to be suitable for human consumption according to European regulations.

A content of less than 10 ppm sulphur dioxide is required in order for the ingredient to be considered allergen-free according to European regulations.

Without being bound by theory, it is the specific treatment of the wet fibrous composition comprising insoluble corn fibers (obtainable as a side-stream from the wet-milling processing of corn) with a neutralizing agent, as discussed below, that reduces the sulphur dioxide content. The wet fibrous composition generally has a sulphur dioxide content of at least 100 ppm, or at least 150 ppm, or at least 200 ppm and at most 500 ppm, or at most 400 ppm, or at most 300 ppm

Sulphur dioxide content of the final composition according to the invention can be measured according to AOAC 990.28.

### Mycotoxin Content

The composition according to the invention is preferably substantially free of mycotoxin contaminants, in particular fusarium fungi mycotoxins.

By “substantially free” it is meant herein below detection limits.

By “mycotoxin contaminants” it is meant herein mycotoxins, for example zearalenone, deoxynivalenol and fumonisins (fumonisin B1, fumonisin B2, fumonisin B3, fumonisin B4).

Corn (also known as maize) is one of the most important crops in the world with an increasing trend towards more production. Diseases caused by Fusarium spp. can affect the yield and grain quality of maize, because of contamination with numerous mycotoxins produced by these fungi. The main mycotoxins include deoxynivalenol, zearalenone and fumonisins (fumonisin B1, fumonisin B2, fumonisin B3, fumonisin B4).

Strict maximum levels for Fusarium mycotoxins (deoxynivalenol, zearalenone and fumonisins) are in place for foodstuffs in the European Union and in other parts of the world.

Preferably, the composition according to the invention has less than 100 μg/kg of zearalenone, preferably less than 90 μg/kg, more preferably less than 75 μg/kg, yet more preferably less than 50 μg/kg. Most preferably, the composition according to the invention is substantially free of zearalenone.

Preferably, the composition according to the invention has less than 2000 μg/kg of fumonisins B1 and B2, preferably less than 1000 μg/kg, more preferably less than 500 μg/kg, yet more preferably less than 100 μg/kg, most preferably less than 50 μg/kg. Most preferably, the composition according to the invention is substantially free of fumonisins B1 and B2.

Preferably, the composition according to the invention has less than 750 μg/kg of deoxynivalenol, preferably less than 500 μg/kg, more preferably less than 250 μg/kg, yet more preferably less than 100 μg/kg, most preferably less than 50 μg/kg. Most preferably, the composition according to the invention is substantially free of deoxynivalenol.

The content of mycotoxins and in particular zearalenone in the final composition according to the invention can be measured according to HPLC-Vicam Mycotoxin test.

According to the invention, the content of mycotoxins and in particular of zearalenone in the final composition can be controlled, by monitoring the fungi in the crop to begin with. Only corn harvests having no occurrence of the relevant fusarium spp. are thus used in the wet-milling corn processing facilities in campaigns where the relevant side-streams can then be used to prepare food-grade side products, such as the composition according to the invention.

### Particle Size

The composition according to the invention preferably has a particle size of from 50 μm to 1.5 mm, preferably from 100 μm to 1.2 mm, more preferably from 150 μm to 1 mm, even more preferably from 200 μm to 1 mm. This range of particle sizes can be achieved by grinding and/or sieving.

In addition, the composition according to the invention may have a particle size distribution D50 of from 300 μm to 700 μm preferably a D50 of from 400 μm to 600 μm. By D50 it is meant the median particle size whereby 50% of the particles by volume have a particle size smaller than that value and 50% of the particles by volume have a particle size greater than that value.

Particle size and particle size distribution D50 can be measured using laser diffraction, for instance a laser diffraction analyzer—Mastersizer 3000.

### Water Content

The composition according to the invention has a water content of less than 15 wt %, preferably less than 12 wt %, more preferably less than 10 wt %, most preferably less than 8 wt %. Preferably, the composition has a water content of at least 1 wt %, more preferably at least 2 wt %.

This low water content can be achieved by drying the wet fibrous composition as discussed below.

The water content can be measured by heating to evaporate all residual water until no water is detected in the IR spectrum and weighing the composition before and after the evaporation. The difference in weight equals the amount of water that was in the sample. From this the wt % of water can be calculated.

### Overall Dietary Fiber Content

The composition according to the invention has an overall dietary fiber content of from 50 wt % to 80 wt %, preferably from 60 wt % to 75 wt % fiber content.

The overall dietary fiber content can be measured according to the method AOAC 2011.25.

### Other Components

The composition according to the invention consists of or essentially consists of components extracted or derived from corn, preferably extracted or derived from the wet-milling processing of corn.

The composition according to the invention comprises not only insoluble corn fiber, but may also comprise soluble fiber, starch, protein and fat. The composition according to the invention may comprise of from 0.01 wt % to 35 wt %, preferably from 0.1 wt % to 30 wt %, or from 1 wt % to 25 wt %, or from 2 wt % to 20 wt %, or from 5 wt % to 15 wt % as the total amount of soluble fiber, starch, protein and fat on a dry weight basis.

The composition according to the invention may comprise of from 0.01 wt % to 10 wt %, preferably from 0.05 wt % to 5 wt %, or from 0.1 wt % to 4 wt %, or from 0.5 wt % to 3 wt %, or from 1 wt % to 2 wt % of soluble fiber on a dry weight basis.

The composition according to the invention may comprise of from 0.01 wt % to 10 wt %, preferably from 0.05 wt % to 5 wt %, or from 0.1 wt % to 4 wt %, or from 0.5 wt % to 3 wt %, or from 1 wt % to 2 wt % of starch on a dry weight basis.

The composition according to the invention may comprise of from 0.01 wt % to 10 wt %, preferably from 0.05 wt % to 5 wt %, or from 0.1 wt % to 4 wt %, or from 0.5 wt % to 3 wt %, or from 1 wt % to 2 wt % of protein on a dry weight basis.

The composition according to the invention may comprise of from 0.01 wt % to 10 wt %, preferably from 0.05 wt % to 5 wt %, or from 0.1 wt % to 4 wt %, or from 0.5 wt % to 3 wt %, or from 1 wt % to 2 wt % of fat on a dry weight basis.

The composition according to the invention may have an ash content of from 0.01 wt % to 1 wt %, preferably from 0.05 wt % to 0.9 wt %, or from 0.1 wt % to 0.8 wt %, or from 0.2 wt % to 0.7 wt on a dry weight basis.

The content of each component i.e., soluble fiber, starch, protein and fat can be measured according to standard methods known in the art.

### Food Products

The invention also relates to a food product comprising the composition according to the invention, and one or more other food ingredients.

The food product preferably comprises from 0.1 to 20 wt %, preferably from 0.5 to 15 wt %, more preferably from 1 to 10 wt % of the composition according to the invention.

The food product can be selected from a processed meat or plant-based meat alternative or restructured meat product. These can be selected from burgers, schnitzel, meatballs, sausages (including but not limited to frankfurters, wieners and bangers), and lunch meats (including but not limited to ham, salami, pastrami, mortadella and meatloaf).

The one or more other food ingredients can be selected from one or more of:
meat, such as beef, lamb, chicken, turkey, or pork;
plant-based proteins, such as protein from legumes (e.g. pea, chickpea, fava, soya, lentils, edamame beans, mung bean), from nuts (e.g. peanuts, almonds, walnuts, cashew nuts, hazelnuts), from cereals (e.g. wheat, rice, corn), from pseudocereals (e.g. quinoa, amaranth, buckwheat), mycoprotein (e.g. Quorn®), from spirulina (algae), from potatoes, from seeds (e.g. chia seeds, hemp seeds), hydrolyzed or not;
dairy-based proteins (from milk), hydrolyzed or not;
egg-based proteins, hydrolyzed or not;
fats, such as, but not limited to cocoa butter, coconut oil, canola oil, olive oil, sunflower oil, dairy butter;
caloric carbohydrates, such as starch, dextrose, corn syrup, glucose-fructose syrup;
salt;
flavor agents, such as heme yeast extract, and coloring agents, such as beetroot extract;
herbs and spices;
preservatives, such as sodium nitrite;
vitamins (such as B1, niacin, B6, B2 and B12) and minerals (such as calcium, iron, potassium, zinc)

### The Process

The invention also covers a process for preparing the composition according to the invention comprising the following steps:
i. Providing a fibrous composition comprising insoluble corn fiber obtainable as a side-stream from the wet-milling processing of corn, wherein the fibrous composition has a water content of at least 40 wt %, preferably at least 50 wt %, more preferably at least 55 wt %, most preferably at least 60 wt %;
ii. Treating the composition with a neutralizing agent to reduce the level of sulphur dioxide in the fibrous composition to below 40 ppm, preferably less than 20 ppm, more preferably less than 10 ppm;
iii. Drying the fibrous composition;
iv. Obtaining a dried composition comprising insoluble corn fiber having a water content of less than 15 wt %, preferably less than 12 wt %, more preferably less than 10 wt %, most preferably less than 8 wt %; and v. Optionally, milling or sieving the dried composition.

The process according to the invention does not require an enzymatic treatment step. The process to obtain the composition from step (iv) or (v) does not comprise an enzymatic treatment step starting from step (i) through to step (iv) or optional step (v).

The fibrous composition comprising insoluble corn fiber provided in step (i) is obtained as a side-stream from the wet-milling processing of corn. This side-stream is usually the side-stream richest in the insoluble fibres from corn. This is usually the side-stream used to prepare corn gluten feed for animals. However, these side-streams are also rich in sulphur dioxide originating from the steeping solution in the wet-milling process. The fibrous composition before step (ii) has a sulphur dioxide content of at least 100 ppm, or at least 150 ppm, or at least 200 ppm and/or at most 500 ppm, or at most 400 ppm, or at most 300 ppm.

In step (ii) the fibrous composition is treated in order to remove sulphur dioxide down to levels acceptable for human consumption i.e., below 40 ppm. Below 40 ppm sulfur dioxide is generally considered to be safe. However, some people are sensitive to it and may develop allergic reactions, such as asthma. Thus, sulphur dioxide levels below 10 ppm is preferred by many food manufacturers.

It was surprisingly found that a neutralizing agent could be used to treat the fibrous composition before drying thereby reducing the sulphur dioxide content down to acceptable levels below 40 ppm, and even below 30 ppm, below 20 ppm, below 15 ppm, or below 10 ppm. The neutralizing agent can be selected preferably from ozone, sodium hypochlorite, hydrogen peroxide, sodium percarbonate, sodium perborate, peracetic acid, benzoyl peroxide, and potassium persulfate.

The treatment is carried out for example by soaking the fibrous composition in a solution of the neutralizing agent. The concentration of neutralizing agent is at least from 0,01% to 1%. Hydrogen peroxide is the preferred neutralizing agent. The fibrous composition is soaked for at least 5 minutes and up to 1 hour in the solution. After soaking the hydrogen peroxide and sulphur dioxide volatilize and do not remain in the composition.

Alternatively, the treatment can also be carried out for example by steadily mixing the fibrous composition with a solution of neutralizing agent for at least 1 minute and up to 1 hour. The concentration of the solution of neutralizing agent is at least from 0.01 wt % to 1 wt %. Hydrogen peroxide is the preferred neutralizing agent. After mixing, the hydrogen peroxide and sulphur dioxide volatilize and do not remain in the composition.

Preferably the drying in step (iii) takes place in a vacuum dryer, tunnel dryer, fluidized bed dryer, or flash dryer.

When the dryer is a vacuum dryer, tunnel dryer, flash dryer or fluidized bed dryer, the temperature in the dryer is preferably from 100 to 125° C., more preferably from 105 to 125° C., and the residence time of the fibrous composition in the dryer is from 5 seconds to 10 minutes, preferably from 5 seconds to 5 minutes, more preferably from 7 seconds to 60 seconds, even more preferably from 10 seconds to 45 seconds, preferably 12 to 20 seconds. The shorter the residence time, the higher the capacity at which the drying can be run.

When the dryer is a vacuum dryer, tunnel dryer or fluidized bed dryer, the temperature in the dryer can also be between 50 to 99° C. However, at these lower temperatures, the residence time of the fibrous composition in the dryer is much longer, preferably from 30 minutes to 4 hours, preferably from 45 minutes to 3 hours, more preferably from 1 to 2 hours, most preferably from 1 to 1.5 hours.

After drying the dried composition comprising insoluble corn fiber according to the invention has a water content of less than 15 wt %, preferably less than 12 wt %, more preferably less than 10 wt %, most preferably less than 8 wt %. Preferably, the composition has a water content of at least 1 wt %, more preferably at least 2 wt %.

After obtaining the dried composition, it can be further sieved or milled to obtain a specific particle size and particle size distribution, as explained above.

The dried composition obtained comprises at least 50 wt % insoluble corn fiber on a dry weight basis and has:
a water absorption capacity of from 2 to 6 times the weight of the composition and
a sulphur dioxide content of less than 40 ppm, making it suitable for a wide variety of applications, in particular in processed meats and plant-based meat analogs.

Thus, the composition according to the invention consists of or essentially consists of components extracted or derived from corn, preferably extracted or derived from the wet-milling processing of corn.

### Use of the Composition

The invention also covers the use of the composition according to the invention in a food product (as described above) to improve the taste and texture of a food product compared to a food product not comprising said composition.

The invention furthermore also covers the use of the composition according to the invention in a food product to improve the water absorption capacity of a food product compared to a food product not comprising said composition.

The food product is a processed meat or plant-based meat alternative or restructured meat product. The food product is preferably selected from burgers, schnitzel, meatballs, sausages and lunch meats.

### EXAMPLE OF THE INVENTION

Textural and technical comparison of a corn fiber-containing sausage according to the invention “Inventive Sausage” against a “Standard Sausage” with no corn fiber included.

Both formulations are typical sausage formulations with 70 wt % beef and the rest being comprised of water, potato starch, added proteins and salts. One of the formulations contained 1.5 wt % corn fiber composition of the invention, the “Inventive Sausage”, which was compared to a “Standard Sausage”. The Standard Sausage contained dextrose instead of the corn fiber to equalize the dry matter in the product.

### Analysis Methods

### Cooking Loss

The water lost from the sausage body, starting from the cooking of the product (followed by cooling/chilling) until the chilling is completed (down to 4° C. degrees) was measured. Cooking was done at 70° C. for 2 hours and then the sausages were transferred to a refrigerator to cool the product down to 4° C. for cooling.

Water loss was measured by weighing the products before and after the cooling and chilling processes with a precision scale.

### Loss During Storage

Loss during storage was measured as the water lost from the meat product during refrigerated storage in vacuum packaging. It can be measured at designated time periods after the beginning of refrigeration, to compare different formulations. Again, measurement was done using a precision scale.

In this case, the time periods to measure loss during storage were at 3 days and 7 days. The formulations were measured for water loss at the end of 3 days refrigerated storage and at the end of 7 days refrigerated storage and compared.

### Hardness

Hardness measurement explains how hard the meat product's structure is after processing is finished. Ideal hardness for most of the meat products gives the product a more whole meat-like texture and sensory properties. It also contributes to the chewiness of the product which is another good property for formulated meat products.

Hardness of the samples were measured by TA-XT Texture Analyzer device for the 2 different sausage formulations.

### Results and Discussion

### Cooking Loss

Cooking water loss was measured in both formulations with 6 replicates of each sausage formulation. Average of the 6 measurements is calculated to reach the below results. Results are found as below, the formulation with corn fiber according to the invention showed more than 10% reduction in cooking water loss, which means that its inclusion yields %10 increase by weight in manufacturer's end product output.

| | Standard Sausage | Inventive Sausage |
|---|---|---|
| Weight loss % | 10.10% | 9.00% |
| after cooking and | | |
| chilling | | |

### Loss During Storage

Loss during refrigeration of 4° C. as mentioned above is calculated for 6 replicates of each formulation again by using precision scales to measure sample weights. Average of 6 measurements from each formulation was calculated to reach the below results.

Results of loss during storage is shown below. As it can be seen, both formulations seem to hold the water well, but the formulation containing the corn fiber of the invention is ahead of the standard one almost by 30%. Loss during storage is another important parameter for the manufacturer, although this affects the plant production output less than cooking loss.

| | Standard Sausage | Inventive Sausage |
|---|---|---|
| Weight loss % Day 3 | 0.53% | 0.38% |
| Weight loss % Day 7 | 0.54% | 0.40% |

### Hardness

Hardness is measured in 4 replicates of each formulation with the TA-XT Analyzer. Just like loss measurements, hardness was also measured and calculated on an average basis.

According to Texture Analyzer results, the formulation according to the invention yielded 25% more hardness in meat product texture and structure than the conventional formulation. This increase gave the Inventive Sausage a more whole meat-like eating experience and also contributes to chewiness which is another importnat parameter for comminuted meat products.

| | Standard Sausage | Inventive Sausage |
|---|---|---|
| Hardness analysis | 29.8N | 36.8N |

1. A composition comprising at least 50 wt % insoluble corn fiber on a dry weight basis, and having
a water absorption capacity of from 2 to 6 times the weight of the composition; and
a sulphur dioxide content of less than 40 ppm.

2. The composition according to claim 1 wherein the insoluble corn fiber comprises on a dry weight basis at least 50 wt % hemicellulose.

3. The composition according to claim 1 wherein the water absorption capacity is of from 3 to 5 times the weight of the composition.

4. The composition according to claim 1 wherein the sulphur dioxide content is less than 20 ppm.

5. The composition according to claim 1 being substantially free of mycotoxin contaminants.

6. The composition according to claim 1 having less than 100 μg/kg of zearalenone.

7. The composition according to claim 1 having a particle size of from 50 μm to 1.5 mm and optionally a D50 of from 300 μm to 700 μm.

8. The composition according to claim 1 having a water content of less than 15 wt %.

9. The composition according to claim 1 having from 50 wt % to 80 wt % fiber content.

10. The composition according to claim 1 entirely obtainable from a side-stream from the wet-milling processing of corn.

11. A food product comprising the composition according to claim 1, and one or more other food ingredients selected from the group consisting of:
meat;
plant-based proteins;
dairy-based proteins;
egg-based proteins;
fats;
caloric carbohydrates;
salt;
flavor agents;
preservatives; and
vitamins and minerals.

12. The food product according to claim 11 wherein the food product comprises from 0.1 to 20 wt %.

13. The food product according to claim 11 wherein the food product is a processed meat or plant-based meat alternative or restructured meat product selected from burgers, schnitzel, meatballs, sausages, and lunch meats.

14. A process for preparing the composition according to claim 1 comprising the following steps:
i) Providing a fibrous composition comprising insoluble corn fiber, wherein the fibrous composition is obtainable as a side-stream from the wet-milling processing of corn, wherein the fibrous composition has a water content of at least 40 wt %;
ii) Treating the composition with a neutralizing agent to reduce the level of sulphur dioxide in the fibrous composition to below 40 ppm;
iii) Drying the fibrous composition;
iv) Obtaining a dried composition comprising insoluble corn fiber having a water content of less than 15 wt %; and
v) Optionally, milling or sieving the dried composition.

15. The process according to claim 14 wherein the fibrous composition in step (i) has a sulphur dioxide content of at least 100 ppm or at least 150 ppm or at least 200 ppm.

16. The process according to claim 14 wherein in step (iii) the fibrous composition is dried in a vacuum dryer, tunnel dryer, flash dryer or fluidized bed dryer.

17. The process according to claim 16 wherein the temperature in the dryer is between 100 to 125° C. and the residence time of the fibrous composition in the dryer is from 5 seconds to 10 minutes.

18. The process according to claim 16 wherein the temperature in the dryer is between 50 to 99° C. and the residence time of the fibrous composition in the dryer is from 30 minutes to 4 hours.

19. Use of the composition according to claim 1 in a food product to improve the taste and texture of a food product compared to a food product not comprising said composition.

20. Use of the composition according to claim 1 in a food product to improve the water absorption capacity of a food product compared to a food product not comprising said composition.

21. The use of the composition according to claim 19 wherein the food product is a processed meat or plant-based meat alternative or restructured meat product, wherein the food product is preferably selected from burgers, schnitzel, meatballs, sausages, and lunch meats.

22. The composition according to claim 1 comprising at least 55 wt % insoluble corn fiber on a dry weight basis, and having
a water absorption capacity of from 2 to 6 times the weight of the composition; and
a sulphur dioxide content of less than 40 ppm.

23. The composition according to claim 1 wherein the sulphur dioxide content is less than 10 ppm.

24. The composition according to claim 1 having less than 90 μg/kg of zearalenone.

25. The composition according to claim 1 having a water content of less than 12 wt %.

26. The use of the composition according to claim 20 wherein the food product is a processed meat or plant-based meat alternative or restructured meat product, wherein the food product is preferably selected from burgers, schnitzel, meatballs, sausages, and lunch meats.
